(19) United States
(12) Patent Application Publication
(10) Pub. No.: US 2024/0119759 A1
(43) Pub. Date: Apr. 11, 2024

(54) SYSTEM AND METHOD FOR COMPUTER VISION ASSISTED PARKING SPACE MONITORING WITH AUTOMATIC FEE PAYMENTS

(71) Applicants: Anil Merchant, Dublin, CA (US); Harris Graves Lummis, Houston, TX (US); Ganesh Sankar Harsha Vardhan Vanama, Eastvale, CA (US); Sai Prajwal Kotamraju, Los Angeles, CA (US); Raghak Radhakrishan, Los Angeles, CA (US)

(72) Inventors: Anil Merchant, Dublin, CA (US); Harris Graves Lummis, Houston, TX (US); Ganesh Sankar Harsha Vardhan Vanama, Eastvale, CA (US); Sai Prajwal Kotamraju, Los Angeles, CA (US); Raghak Radhakrishan, Los Angeles, CA (US)

(21) Appl. No.: 17/962,169

(22) Filed: Oct. 7, 2022

(51) Int. Cl. G07B 15/02; G06Q 20/10; G06Q 20/36; G06Q 30/02; G06Q 30/04; G06V 20/40; G06V 20/54; G08G 1/017

(52) U.S. Cl. CPC G07B 15/02; G06Q 20/102; G06Q 20/3676; G06Q 30/0284; G06Q 30/04; G06V 20/46; G06V 20/54; G08G 1/017; G06Q 2220/00; G06V 2201/08

(57) ABSTRACT

A system and method for computer vision assisted parking space monitoring, vehicle identification, transactionable event determination, calculation of parking fees, invoice generation, user communication, and automated payment processing from a registered user via a registered user account with prior user authorization or by sending the invoice to unregistered users or third parties who may contact unregistered users.

### FIELD OF THE INVENTION

The present invention generally relates to a system and method for monitoring, regulating, and automating payments for curbside parking. More particularly, the present invention combines computer vision technology with vehicle identification, tagging, and tracking software with systems having user databases and automated payment options to provide contactless and effortless invoicing and payment for an individual's use of a monitored parking space.

### BACKGROUND OF THE INVENTION

Parking lots and curbside parking meters are commonly used to supply drivers with places for those drivers to leave their vehicles. Both private and public controllers often supply these parking services for the benefit of drivers and usually choose to monetize for the time a vehicle is parked in any particular parking lot or curbside parking space. This monetization may be collected by individuals, meters, or automated systems. Further, compliance with parking laws, regulations, and guidelines may be enforced either autonomously or by individual parking service employees.

More recent developments have seen the rise of contactless monetization and payment for drivers to use parking lots and curbside parking spaces. This contactless monetization includes methods such as prepaying and providing vehicle information, ticket with kiosk payment systems, parking meters including payment mechanisms such as coin and credit card receivers, and mobile applications allowing for parking spot designation and payment for desired length of time. These systems may cause drivers various issues with payment, time allotted, time spent interacting with the system, and mobile device issue concerns among other issues. Likewise, private and public controllers of these parking services may have less than ideal solutions with monitoring and enforcing payment for their services as well as transactional issues with the monitoring and payment systems.

### SUMMARY OF THE INVENTION

The following presents a simplified summary of the present invention to provide a basic understanding of the invention's concepts. This summary is not an extensive overview, and it is not intended to identify critical elements or to limit the scope of this disclosure. The sole purpose of this summary is to present some general concepts in a simplified form as a prelude to the detailed description of the invention.

The subject matter disclosed and claimed herein, in some embodiments of the present invention, relates to a method for detecting, tracking, managing, and charging for parking space usage, the method comprising sensing at least one vehicle's appearance into at least one image frame, capturing at least one image of the at least one vehicle's appearance into the image frame, and the at least one vehicle's ingress to and occupancy of at least one monitored parking space, storing the at least one image within a medium of computer readable memory with a beginning timestamp identifying the at least one vehicle's ingress to the at least one monitored parking space, identifying at least one parameter of vehicle identification for the at least one vehicle, tracking the at least one vehicle's presence in a plurality of the at least one images, wherein the computer vision system includes tracking software that accounts for obstructions that may prevent the capture of images of the at least one vehicle in the at least one image frame, sensing the at least one vehicle's egress from the at least one monitored parking space, capturing at least one image of the at least one vehicle's egress from the at least one monitored parking space with an ending timestamp identifying the at least one vehicle's egress from the at least one monitored parking space, storing the at least one image within the medium of computer readable memory, verifying the at least one parameter of vehicle identification for the egressed at least one vehicle parked in the at least one monitored parking space, transmitting data captured from the at least one computer vision system to a server pertaining to the at least one vehicle's ingress, presence, and egress from the at least one monitored parking space and the at least one parameter of vehicle identification, calculating the duration of time between the at least one vehicle's ingress to and egress from the at least one monitored parking space, calculating a fee for the duration of time that the at least one vehicle occupied the at least one monitored parking space, determining whether the at least one vehicle is subject to at least one additional fee, determining whether a transactionable event has occurred by the at least one vehicles ingress, presence, and egress from the at least one monitored parking space, calculating a total fee that is a combination of the fee and, if applicable, the at least one additional fee, generating an invoice for the total fee owed for the at least one vehicle's ingress, presence, and egress from the at least one monitored parking space, verifying whether the identified at least one vehicle is connected to a user's registered user account within at least one user database, wherein the registered user account on the at least one user database includes a pre-registered payment method and a pre-authorization for charges associated with fees for the at least one vehicle connected to the registered user account, and sending the total fee on the invoice to the registered user for the at least one vehicle's ingress, presence, and egress from the at least one monitored parking space. And, ideally, automatically charging the total fee on the invoice to the user's registered user account thanks to a supplied payment method and pre-authorization for charges related to the at least one vehicle's parking transactions.

The subject matter disclosed and claimed herein, in some embodiments of the present invention, relates to an automated curbside parking system, the system comprising at least one capture device directed to capture at least one image of at least one vehicle's appearance in at least one image frame, and the at least one vehicle's ingress into and egress from at least one monitored parking space, at least one computer processor, at least one unit of computer memory containing at least one set of instructions controlling the operation of the computer vision system, identifying at least one parameter of vehicle identification for the at least one vehicle, tracking the at least one vehicle's presence in the at least one image, and for storing the at least one image captured by the at least one capture device, and at least one communication unit; at least one server comprising at least one computer processor, at least one unit of computer memory containing at least one set of instructions. wherein the at least one set of instructions includes at least one Policy API, at least one invoice generating routine, at least one payment gateway, and at least one user interface, at least one network interface, the at least one monitored parking space that is monitored by the computer vision system; wherein the computer vision system is configured to sense the at least one vehicle's appearance into the at least one image frame, capture at least one image of the at least one vehicle's appearance into the image frame, and the at least one vehicle's ingress to and occupancy of at least one monitored parking space, store the at least one image within the medium of computer readable memory, identify at least one parameter of vehicle identification for the at least one vehicle, track the at least one vehicle's presence in a plurality of the at least one images, wherein the computer vision system's instructions for tracking accounts for obstructions that may prevent the capture of images of the at least one vehicle in the at least one image frame, sense the at least one vehicle's egress from the at least one monitored parking space, capture at least one image of the at least one vehicle's egress from the at least one monitored parking space, store the at least one image within the medium of computer readable memory, verify the at least one parameter of vehicle identification for the egressed at least one vehicle parked in the at least one monitored parking space, transmit data captured from the at least one computer vision system to the at least one server pertaining to the at least one vehicle's ingress, presence, and egress from the at least one monitored parking space and the at least one parameter of vehicle identification; wherein the server is configured to receive the computer vision system's data via the server's network interface, calculate the duration of time between the at least one vehicle's ingress to and egress from the at least one monitored parking space, calculate a fee for the duration of time that the at least one vehicle occupied the at least one monitored parking space, determine whether the at least one vehicle is subject to at least one additional fee, determine whether a transactionable event has occurred by the at least one vehicles ingress, presence, and egress from the at least one monitored parking space, calculate a total fee that is a combination of the fee and, if applicable, the at least one additional fee, generate an invoice for the total fee owed for the at least one vehicle's ingress, presence, and egress from the at least one monitored parking space, verify whether the identified at least one vehicle is connected to a user's registered user account within at least one user database, wherein the registered user account on the at least one user database includes a pre-registered payment method and a pre-authorization for charges associated with fees for the at least one vehicle connected to the registered user account, and transmit the invoice to the registered user for the at least one vehicle's ingress, presence, and egress from the at least one monitored parking space.

To the accomplishment of the foregoing and related ends, certain illustrative aspects of the disclosed innovation are described herein in connection with the following description and the annexed drawings. These aspects are indicative of only a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The embodiments of the present invention disclosed herein are illustrated by way of example, and not by way of limitation, in the figures of the accompanying drawings, in which like reference numerals may refer to similar elements.

FIG. 1 is an exemplary embodiment of a computer vision system tasked with monitoring at least one monitored parking space.

FIG. 2 is an exemplary embodiment of a method for a server invoicing a user for the user's parking fee.

FIG. 3 is an exemplary embodiment of a method for a user registering an account for an autonomous parking fee system.

FIG. 4 shows a diagram of an exemplary configuration of the system of one embodiment of the present invention.

### DETAILED DESCRIPTION OF THE PRESENT INVENTION

The innovation is now described with reference to the drawings, wherein reference numerals are used to refer to elements throughout. In the following description, for purposes of explanation, numerous specific details are set forth to provide a thorough understanding of the present invention. It may be evident that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As mentioned, despite there being many metered parking solutions such as parking lot attendants, kiosks, parking meters, identification and/or tag systems, and several application or web-based solutions, there still exists a need for a parking solution that includes automated billing and fee adjustment based on smaller windows of time. Therefore, a computer vision assisted parking system that charges users for parking for smaller increments of time (such as every one or five minutes) is ideal for users and for operators of the parking systems. This smaller increment and monitoring of parking spaces via the computer vision system cuts down on costs associated with labor related to parking enforcement. Further, it is convenient for users because a user with a registered user account may simply park in a space, exit their vehicle, continue to their destination, return to their vehicle, enter the vehicle and drive away from the parking space without any time spent paying parking fees. Even further conveniences are that the user is charged in a narrower window of time and does not have to guess the duration of their parking needs beforehand, as is the case for prepaid meters and similar means.

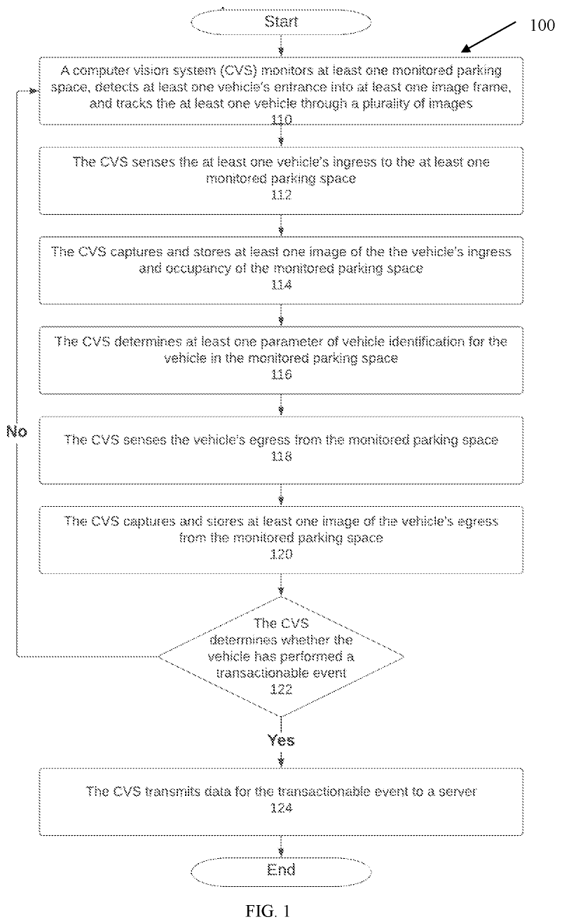

FIG. 1 is an exemplary embodiment of a method for a computer vision system tasked with monitoring at least one monitored parking space. In some embodiments of a method for monitoring a monitored parking space and transmitting transactionable events to a server 100, a computer vision system (CVS) monitors at least one monitored parking space, detects at least one vehicle's appearance into at least one image frame, and tracks the at least one vehicle through a plurality of images 110. In some embodiments, the CVS includes at least one capture device (such as camera hardware), at least one computer including at least one processor, computer readable memory, a network connection to a server, and other necessary components typically found in computer devices, and specialized algorithms and instructions to detect, monitor, track, evaluate, identify, calculate, and determine the occurrence of events in the system. Events include the at least one vehicle's first appearance in the at least one image frame, identifying the vehicle, detecting the vehicle's ingress, presence, and egress from the monitored parking space (aka “tracking” the vehicle), determining whether a transactionable event occurred, and more. In further embodiments, the CVS includes specially trained algorithms and sets of routines and/or instructions that focus on sensing a vehicle's ingress, presence, and egress from a monitored parking space (including algorithms that account for obfuscation or occlusion of the vehicle during any part of the foregoing), collecting at least one type of identifying information for a vehicle, and determining if a transactionable event has occurred. Image frames are the boundaries of at least one image and may be a single image frame generated by one capturing device or a more comprehensive, collection of image frames that may be generated by multiple capturing devices recording images from multiple angles of the monitored parking space.

In some embodiments, the CVS may track and/or capture at least one image for the at least one vehicle throughout the entirety of the vehicle's presence in the plurality of images. Further, identifying tags or markers may be added to the images to allow the tracking of said vehicle between images. This enables the CVS to track the vehicle and determine the duration of the vehicle's stay in the at least one monitored parking space. In some embodiments, the CVS may include tracking software that accounts for obstructions that prevent capturing of any at least one vehicle's presence in any of the plurality of images. Those skilled in the art will appreciate that, in some embodiments of the present invention, multiple capture devices positioned to capture multiple angles of the at least one monitored parking space reduces the likelihood of the at least one vehicle being completely obstructed from all viewing angles.

It should be appreciated by those skilled in the art that “monitored parking space” is an inclusive term that generally means a defined area where a vehicle could be parked. The reasons for parking the vehicle in the defined area could be non-commercial or commercial (such as a curbside loading zone). In some embodiments, the monitored parking space or monitored parking spaces may have distinct markings of the dimensions of each parking space or they may be a larger, less obviously marked areas suited for larger vehicles (such as a semi-trailer truck) or multiple consumer vehicles. Further, and for an abundance of clarity, “monitored parking space” could include any number of curbside spaces that are not distinctly marked but are monitored as a block, line, or other suitable formation of parking spaces.

In some embodiments, the CVS senses the at least one vehicle's ingress to the at least one monitored parking space 112. The CVS may include algorithms that are trained to determine whether a vehicle has sufficiently ingressed into any monitored parking space. This training may include adaptable conditions to raise the CVS's tolerance of false positive ingresses into any monitored parking space (such as when a vehicle rolls through one space and into another or if a vehicle egresses from the monitored parking space almost immediately).

In some embodiments, the CVS captures and stores at least one image of the ingressing vehicle and the vehicle's occupancy in the monitored parking space 114. In some embodiments, at least one image is captured of the ingressing vehicle. This image ideally displays the vehicle's ingress as well as at least one parameter of vehicle identification. Further, the CVS may include a beginning timestamp identifying the ingress and start of the at least one vehicle's occupancy of the at least one monitored parking space.

In some embodiments, the sensing, capturing, and storing of any data occurs in real time at set intervals. These set intervals may be from a range from fractions of a second to minutes apart. Further, the CVS may monitor and sense continuously but only capture and store images when the vehicle first enters the image frame, and the vehicle's ingress, occupancy, or egress from the monitored parking space is detected. Even further, some CVSs may also capture and store images at set intervals such as every 60 seconds to generate a record of any number of vehicles' ingress, presences, and egress from any number of monitored parking spaces. Additionally, in some embodiments of the present invention, the images may further display vehicle identification information.

In some embodiments, the CVS determines at least one parameter of vehicle identification for the vehicle occupying the monitored parking space 116. The at least one parameter of vehicle identification may be recognition of the vehicle's make, vehicle's model, license plate, vehicle's color, other identifying details of the vehicle, an identifying tag, an identifying sticker, a transmitter, etc. Identification may occur on the edge (that is to say, by local devices), by the computing hardware of the nearest CVS, by a server within the greater system that promotes the method of the present invention, by a third party application or system, or by another similar means. The determination of at least one parameter of vehicle identification may occur at different points throughout the method such as when the vehicle first enters the image frame, when the vehicle is first detected within any image (in case there was possible delay in detection due to one or more obstructions), when the vehicle ingresses into a monitored parking space, or some other suitable point for the purposes of tracking the vehicle.

In some embodiments, the CVS senses the at least one vehicle's egress from the at least one monitored parking space 118. The sensing of the vehicle's egress is also due to trained algorithms or sets of computer instructions. Also, like the vehicle's ingress, these algorithms may include conditions to prevent false positives, triggers, or reporting.

In some embodiments, the CVS captures and stores at least one image of the vehicle's egress from the vehicle's previously occupied parking space 120. Unlike the vehicle's ingress and presence within the monitored parking space, the vehicle's egress naturally means that the vehicle will likely be exiting the CVS's range of operation and vision. Therefore, the CVS may include trained algorithms or instructions to begin capturing images at short set intervals when a vehicle's egress is sensed. This increases the likelihood that the vehicle's at least one parameter of vehicle identification is captured during the vehicle's egress. Further, the CVS may include an ending timestamp identifying the end of the at least one vehicle's occupancy of the at least one monitored parking space.

In some embodiments, the CVS determines whether the vehicle has performed a transactionable event 122. A transactionable event may include the vehicle's ingress to the monitored parking space, the vehicle's egress from the monitored parking space, the amount of time the vehicle occupied the monitored parking space, or combinations of the preceding. In further embodiments, the CVS includes software policy instructions for the system that may limit what can be determined as a transactionable event. For example, the CVS's operator may desire transactionable events to only occur on certain days, during certain time periods, for certain vehicles, etc.

In some embodiments, when the CVS has determined that the transactionable event has occurred, the CVS then transmits the data related to the transactionable event to a server 124. Captured data may include images of the vehicle, images of the vehicle's ingress, presence, and egress from the monitored parking space, calculations for the duration of the vehicle's occupancy of the monitored parking space, vehicle identification data, policy data, CVS system data, and other data related to the operation of the CVS, method, and server.

In the depicted embodiment, the CVS determines whether a transactionable event has occurred prior to transmitting the data to the server; however, alternate embodiments may have the CVS transmit the data related to a potential transactionable event to the server which allows the software on the server to determine whether a transactionable event has occurred. Those skilled in the art will appreciate that these steps are interchangeable and primarily depend on the deployment of hardware and software solutions to facilitate the system and method of the present inventions. One view of the choice may be between having more investment in hardware and software for the computer vision system to lessen network traffic and the computing and storage power of the server. Alternatively, deployers of the system and method may want less hardware and software investment in the computer vision system which could be subject to weather issues, traffic accidents, or other sources of potential equipment damage and/or disruption.

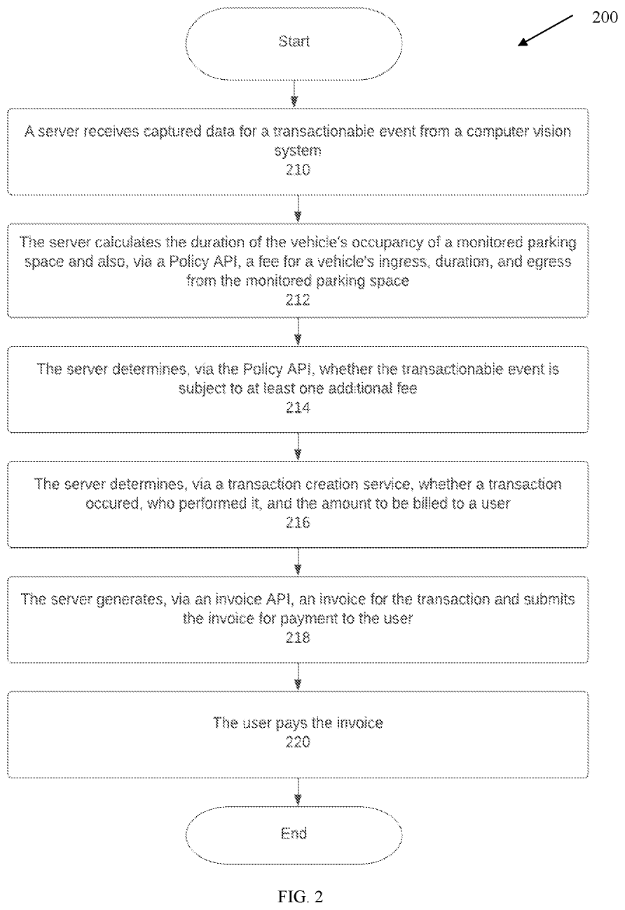

FIG. 2 is an exemplary embodiment of a method for a server invoicing a user for the user's parking fee. In some embodiments, a method for a server to invoice a user 200 begins by the server receiving the captured data from the CVS regarding the transactionable event 210.

In some embodiments, the server calculates the duration of the vehicle's presence or occupancy of the monitored parking space and also, via a Policy API, a fee for the vehicle's ingress, duration, and egress from the monitored parking space 212. Most commonly, the duration of the vehicle's presence within the monitored parking space is the span of time between the vehicle's ingress and the vehicle's egress. Further, ingression and egression times may be rounded or truncated to the nearest minute for simplicity of calculation of the duration. Even further, some embodiments may include a grace period (such as any duration under 5 minutes) wherein the vehicle's owner is not invoiced and charged for the vehicle's use of the monitored parking space.

In some embodiments, the Policy API provides computer-readable instructions for the server related to policy information for the at least one monitored parking space, determines whether a particular event (session at the curb) qualifies as a transactionable event, calculates the fee for the vehicle's ingress, presence, and egress from the monitored parking space, determines whether at least one additional fee is required for the transactionable event, calculates a total fee, performs system diagnostics, provides notices to the system owner or third parties, and more. Policy information may relate to hours of operation, parking availability, rates for parking in the at least one monitored parking space, etc. In some embodiments, the Policy API may notice a violation (parking or otherwise) and send a notice to a third party.

In some embodiments, the system determines, via the Policy API, whether the transactionable event is subject to at least one additional fee 214. Examples of the at least one additional fee include initial and/or flat fees for the vehicle's ingress into the monitored parking space, flat fees for overnight parking (particularly if the CVS does not record between certain hours of the day such as from midnight to 6 AM), fees for the vehicle's presence in the monitored parking space beyond the allowable maximum stay (for example, if a particular monitored parking space only allowed the same vehicle to occupy it for 2 hours and a vehicle stayed beyond that time limit), and fees for oversized vehicles or vehicles not safely occupying the monitored parking space.

In some embodiments, the server verifies, via a transaction creation service, whether a transactionable event has occurred, who performed it, and the amount to be billed to the user 216. The transaction creation service communicates with the Policy API to determine whether the vehicle's ingress, presence, and egress from the at least one monitored parking space qualifies as the transactionable event. Further, the transaction creation service, potentially with the aid of other instructions, conditions, modules, APIs, etc., identifies the vehicle and confirms whether the vehicle is connected with a registered user account.

In some embodiments, the server generates, via an Invoice API, an invoice for the transactionable event and submits that invoice for payment by the user 218. The Invoice API performs a calculation based on the fee for the vehicle's presence in the monitored parking space (this is commonly a simple formula of “duration of stay” multiplied by “rate per hour”) and any other additional fees (such as a flat fee to enter the space or a fee for staying beyond an allowed time limit) to determine the total fee. The total fee may be the only charge present on the invoice or the charges may be broken down into the fee and any additional fees. This invoice may be submittable or sent to the user via connected information on a registered user account (such as a phone number or email address), to an email or phone number retrieved from a third party database containing user information tied to the vehicle, or via physical mail to an address retried from a third party database containing owner information for the vehicle. Alternatively, the invoice may merely be a transaction notice within the system, never reaching the user before payment is charged, that causes the processing of the user's pre-authorized payment method for the user's parking. Even further, “invoice” as used within the method and system of the present invention may also mean the general concept of sending, requesting, charging, and/or automatically processing an amount owed for a transaction. Meaning the invoice is generated and used by the method and/or system to determine which register user to charge, but the relevant registered user does not need to receive, review, and manually pay the invoice.

In some embodiments, an invoice for the aggregate total fee may be generated from multiple occurrences of the user's at least one vehicle occupying one or more monitored parking spaces. These aggregate total fee invoices may be generated by the server or by a third party processor.

In some embodiments, the user pays the invoice 220. This payment transaction may be an automatic payment transaction that is processed by the system and based on the user's settings in the user's registered user account. The user's payment may be made by the user either actively through a payment gateway or passively (from the user's perspective) from a pre-arranged, automated payment method. One example of a user's active payment is the user, having parked in the monitored parking space and exited their vehicle, using their mobile device to log in to a website or application to assist the user with payment of the parking fee. This payment, in some embodiments, may be made before the user exits the monitored parking space in the user's vehicle (in which case the user likely must estimate their total stay time) or after the user has entered their vehicle and left the monitored parking space. If the user has left the parking space and does not pay for their total fee, the user may be subject to additional fees for late payment. Further, the CVS and system of the present invention may search for the user's information to send an invoice or provide the user and/or the user's vehicle information to third parties and/or parking authorities.

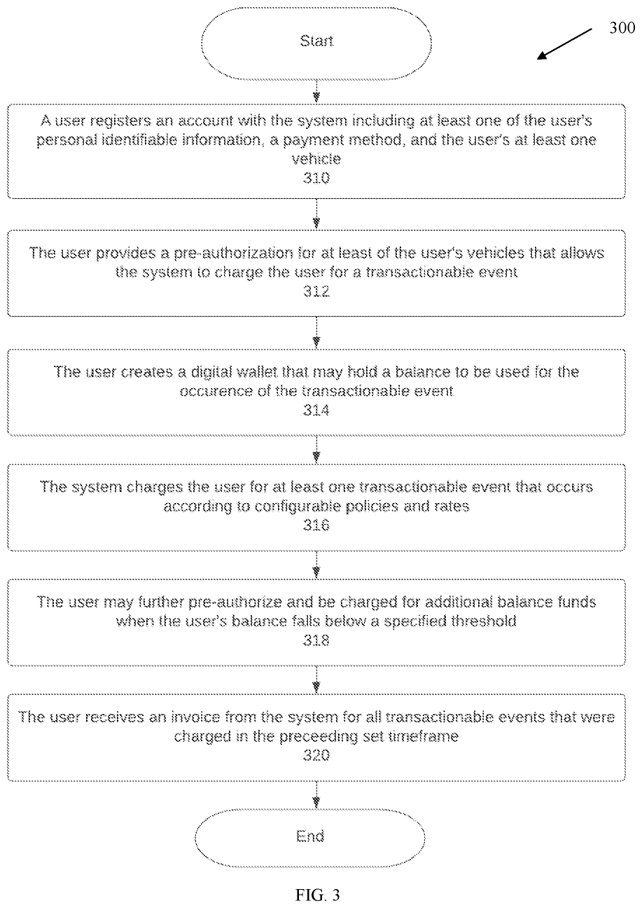

FIG. 3 is an exemplary embodiment of a method for a user registering an account for an autonomous parking fee system. In some embodiments, the user's account registration and automated invoice payment 300 begins when the user registers an account with the system including information such as at least one of the user's personal identifiable identification (“PIP”), a payment method, and/or the user's at least one vehicle 310. PII includes identifying information such as the user's name, date of birth, address, email address, telephone number, driver's license number, etc.

In some embodiments, the user provides the system with a pre-authorization for at least one of the user's vehicles that allows the system to charge the user for any transactionable events involving the user's registered vehicles 312. One benefit of the present invention is that the user's onetime setup of that user's registered user account allows for automated payments. Therefore, user s do not have to spend time on their mobile devices or with a parking interface apparatus (such as a parking meter or kiosk) to pay for their vehicle's occupancy of the monitored parking space. This saves users time and, in many cases, money because the users do not have to estimate and add time to the system in accordance with their parking needs.

In some embodiments, the user creates a digital wallet that may hold a balance to be used for payment of any applicable transactionable events 314. The user's one or more digital wallets may work as a deposit account(s) or similar to a gift card account(s) as used by companies like Starbucks® or Amazon® where funds are stored and available for use within the system and only the system. In some embodiments, deposited funds are removable back to the user's original payment method. Additionally, in some embodiments, the digital wallet may store international currencies and operate on an exchange rate to local currency before charging the user. Additionally, the user may use digital currencies such as bitcoin, ether, and the like.

In alternative embodiments, the user may register a pre-registered payment method such as a credit card, a debit card, or a bank account in replace of, or addition to, the user's digital wallet. All payment methods that may be used with the method and system of the present invention that allow for digital payments for the relevant services are considered a “pre-registered payment method.”

In some embodiments, the system charges the user for at least one transactionable event that occurs accounting to the system's configurable policies and rates 316. The user may be charged nearly instantly after the user's vehicle leaves the monitored parking space, after a set number of minutes or hours, at the end of the day, week, month, etc., whatever the system's operator desires. The system operator may also decide to charge based on the number of transactionable events. Or, the system operator may charge based on some formula or parameters involving the amount of time after a transactionable event or a number of transactionable events.

In some embodiments, the user may further pre-authorize and be charged for additional balance funds when the user's balance falls below a specified threshold 318. In the event that the user does not have enough funds in their digital wallet, the system may refill the wallet from the user's pre-set payment method such as a credit card transaction or bank account withdrawal.

In some embodiments, the user receives the invoice from the system for all transactionable events that were charged in the preceding set timeframe 320. The frequency of invoices may, in some embodiments, may be changeable according to the user's registered user account settings with the system. Alternatively, the frequency of invoices may be determined by the service provider and/or system operator.

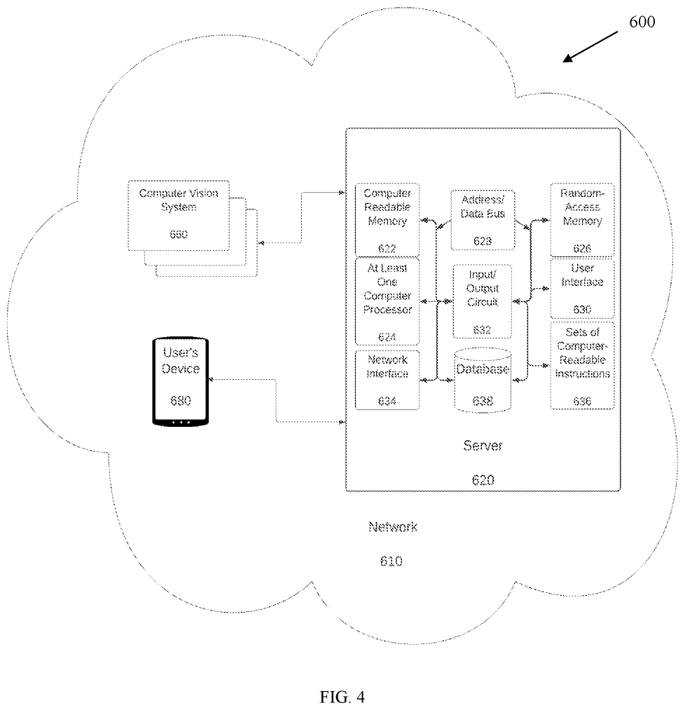

FIG. 4 shows a diagram of an exemplary configuration of the system of one embodiment of the present invention. A system for computer vision assisted parking space monitoring and charging (or merely “system”) 600 includes a user's device 680, a computer vision system 660, both connected to a server 620 via a network 610.

Some examples of the user's device 680 include a cellular phone, a tablet, a computer, or any other device that a system application may be installed on or that can access a website for the system 600. The system application or website uses the resources of the user's device, displays information to the user, and facilitates interactions with the user through the graphical user interface and the input/output mechanisms of the user's device. Input/output mechanism includes a touch screen, physical keyboard, voice recognition and typing, and other methods known in the art. The application or website communicates with the server 620 via a network 610.

In some embodiments, the computer vision system 660 may include some or all of the same components of the server 620 in addition to the components necessary for the computer vision process. The computer vision system 660 may also include necessary hardware components such as camera(s), housings, lighting components, optical components, computer processing units, graphical processing units, frame grabbing mechanisms (hardware and/or software), or other specialized hardware that works in conjunction with the camera(s) for gathering and processing image data. The frame grabbing hardware, or simply “frame grabber,” may be analogue or digital device and includes software components directed to image capture, retention and/or improvement of image quality, and transmission of the frame grabbed image to the computer vision system 660. Improvements of image quality include sharpening, coloring adjustment, and, in some embodiments, machine learning driven enhancements to aid in identification of vehicles and/or parking space monitoring.

If necessary for the operation of the system 600, lighting may be provided by components that are part of the computer vision system 660 such as lighting devices like an LED bulb, it may from devices outside the system 600 (for example: street lamps), or it may be natural light.

The computer vision system 660 includes a communication unit which allows the computer vision system to communicate over the network. The communication unit includes its own network interface which may be adapted to communicate via internet, LANs, infrared networks, mobile networks, satellite networks, LoRaWAN®, mesh networks, and other networks suited to transferring the data used in the system 600. Data sent from the computer vision system 660 to the server 620 includes at least one of the following: vehicle identification data, duration of the at least one vehicle's ingress, presence, and egress from the monitored parking space, determination of transactionable event, image data, video recording data, system diagnostic data to notify the server 620 of any status updates or issues with the computer vision system 660, or any other data that promotes the purpose and/or operation of the method and system 600.

In some embodiments, the camera or other capture device may be separate from most of the other components of the computer vision system 660. Regardless of length of separation between any capture device and the computer vision system 660, the capture device is capable of adequately relaying data to the computer vision system 660 for the purposes of the present invention. In further embodiments, the capture device includes at least one computer processor, computer readable memory, a network interface, and at least one set of instructions to facilitate the capture device's function within the computer vision system 660. The capture device's at least one set of instructions may include vehicle sensing software, vehicle identification software which identifies at least one parameter of vehicle identification, timing software, image reformatting software, tracking software for tracking the at least one vehicle's presence in the at least one image, instructions for storing the at least one image captured by the at least one capture device, and more.

In some embodiments, the tracking software may include highly complex and optimized, or machine learning derived, routines that specializes in tracking and/or anticipating an obscured vehicle's location within the image frame. In some embodiments, the tracking software may rely, or partially rely, on distance based tracking in relation to the obstruction and the at least one vehicle. For example, if a car is occluded farther in the image frame, the search area for re-identification is smaller as the vehicle appears smaller. And, if the same vehicle got occluded closer to the camera, due to its size being bigger, the search area is larger.

In some embodiments, this tracking software may calculate the beginning timestamp and/or the ending timestamp for the vehicle's ingress, occupancy, and egress from the monitored parking space if any of those events or durations where obscured. For example, if a monitored parking space was obscured when a vehicle entered the monitored parking space, the computer vision system 660 may identify the already parked vehicle, including at least one parameter of vehicle identification, and assign the beginning timestamp based on the first image displaying the vehicle within the monitored parking space. Alternatively, the tracking software may calculate the beginning timestamp based on identifying the vehicle entering the image frame, being obscured, and then being detected within the monitored parking space. In one scenario for an embodiment of the tracking software, a delivery truck obstructs the view of the monitored parking space, a vehicle enters the image frame and is assigned at least one parameter of vehicle identification, the vehicle is obstructed by the delivery truck, the computer monitoring system 660 does not see the vehicle drive past the delivery vehicle or otherwise reappear in the image frame, the delivery truck moves and no longer obstructs the monitored parking space revealing the vehicle, and the tracking software re-verifies the vehicle's identifying parameter and calculates the beginning timestamp for a few seconds or minutes after the vehicle was obstructed by the delivery vehicle. Likewise, a similar scenario can be imagined wherein the computer vision system's 660 tracking software sees a vehicle leave the image frame after being obstructed while being in the monitored parking space, allowing the tracking software to calculate the ending timestamp.

The server 620 includes computer readable memory (often referred to as “program memory” or “memory”) 622, at least one computer processor (sometimes referred to as a controller, a microcontroller, or a microprocessor 624, a random-access memory (“RAM”) 626, an address/data bus 628, a user interface 630, an input/output (“I/O”) circuit 632, a network interface 634, at least one set of computer-readable instructions 636, and at least one database 638. All of the components of the server 620 are interconnected via the address/data bus 628. The memory 622 may comprise one or more tangible, non-transitory computer-readable storage media or devices, and may be configured to store computer-readable instructions that, when executed by the at least one computer processor 624, cause the server 620 to implement processes necessary for the operation of the system 600.

The memory 622 may store multiple sets of computer-readable instructions 636 and organize them into modules that can be executed to implement the system 600. In one embodiment, the memory 622 stores multiple sets of computer-readable instructions 636 that cause the server 620 to send and receive data to and from the system application or website on the user's device 680. The memory 622 may store fewer or additional sets of computer-readable instructions on the server 636 in accordance with the necessities of the system 600. Computer-readable instructions 636 include executable features that cause the computer to generate, receive, send, verify, compute, or otherwise perform some computation to aid in furthering the purpose of the present invention. In some embodiments, the computer-readable instructions 636 may be stored as processes, scripts, applications, and/or modules. In some embodiments, the computer-readable instructions 636 may be stored as routines, subroutines, or other blocks of instructions. In some embodiments, these routines, subroutines, or other blocks of instructions include a Policy API that provides parking rules, rates, timetables, and other related services to the system, an invoice generating routine or API to create invoices for transactionable events, and a payment routine or API. Further, these routines or APIs may be provided to the system and/or the server by third party services or programs.

In some embodiments, the system 600 includes at least one external database that communicates with the server 620 to provide information related to the operation of the system 600, vehicle data, user data, driver data, and/or parking data. Further, any external database may be owned by third parties such as a government body like the department of motor vehicles of any state which may provide driver and vehicle data or a private body like an insurance company's database which may also have driver and vehicle data.

The server 620 may be operatively connected to send and receive communications, data, requests, and/or responses over the network 610 via the I/O circuit 632 and network interface 634. The server 620 may connect to the network 610 at the network interface 634 via a wired or wireless connection, or other suitable communications technology. The network 610 may be one or more private or public networks. The network 610 may be a proprietary network, a secure public internet, a virtual private network, a cellular/mobile network, or some other type of network, such as dedicated access lines, plain ordinary telephone lines, satellite links, combinations thereof, etc. Where the network 610 comprises the Internet, data communications may take place over the network 610 via an internet communication protocol. Data is exchanged between the user's device 680, the computer vision system 660, and the server 620 via the network 350.

The server 620 may receive the user's information from the system application or accessed website on one or more of the user's devices 680 via the network 610. The server 620 may also request data or information from system application or accessed website on one or more of the user's devices 660 via the network 610.

In some embodiments, at least one database 638 may be configured to store data related to and/or generated by the system 600. Any database (in the server 620, in the computer vision system 660, or from elsewhere) may be used to store various data and information, including information about the user (including PII), information received from the user, information about the user's vehicle, web traffic metrics, user driving metrics and details, geographic data from the user's device 680, and/or any other data or information that is measurable and/or recordable through the use of the system 600. In ideal embodiments, the server 620 includes at least one database of registered user accounts.

In some embodiments, the server 620 may connect to external systems (either private or publicly owned) to access vehicle and driver data in order to invoice an unregistered user. For example, if the unregistered user parks in one of the monitored parking spaces of the system for two hours and then leaves, the system 600 may first have a built-in grace period that waits for the unregistered user to register and account or process a one-time payment via a website or kiosk. After the grace period, the system 600 may then communicate with a third-party resource such as the state department of motor vehicles for corresponding to the state of a license plate on the unregistered user's vehicle. The information from the DMV may include an address for the unregistered user for the system 600 to cause a paper invoice to be mailed to the unregistered user. In further embodiments, this paper invoice also includes instructions for downloading the application and registering an account with the system 600 for the user's future convenience. If the user ignores the invoice, the system 600 may further relay the nonpayment to authorities and/or it may flag the unregistered user's vehicle for action after a configurable number of nonpayment events occur. Alternatively, payments due for vehicles that are not associated with a registered user account may have their information supplied to third parties who may seek payment for the invoice. These third parties could be contracted private or government entities.

In some embodiments, the system 600 includes at least one user-facing application installed on the user's device 680 and configured to allow the user to interact with the system via a graphical user interface which provides the user with the ability for the user to register an account, edit account details, add at least one payment method, register at least one vehicle to the registered user account, and provide at least one pre-authorization for the at least one payment method which covers charges related to the at least one vehicle's parking fees, fines, and charges and/or refilling of the user's digital wallet.

In alternative embodiments, the system 600 includes at least one user-facing website configured to allow the user to interact with the system via a graphical user interface which provides the user with the ability for the user to register an account, edit account details, add at least one payment method, register at least one vehicle to the registered user account, and provide at least one pre-authorization for the at least one payment method which covers charges related to the at least one vehicle's parking fees, fines, and charges and/or refilling of the user's digital wallet.

Although the components of the system 600 and/or the server 620 are shown in single blocks in the diagram, it should be understood that the memory 622, RAM 626, I/O circuit 632, and other components may be made up of multiple, a set, or a series of those components. For example, there may be several RAM 626 components (sometimes called “RAM sticks”) installed within the server 620.

In some embodiments, the server 620 may include a payment gateway for the user to pay the invoice. In alternative embodiments, the server 620 may direct the user to a third-party (such as Stripe, Adyen, or PayPal) external payment gateway to process the payment of the invoice.

It should be understood that any of the examples described herein may include various other features in addition to or in lieu of those described above. By way of example only, any of the examples described herein may also include one or more of the various features disclosed in any of the various references that are incorporated by reference herein.

It should be understood that any one or more of the teachings, expressions, embodiments, examples, etc. described herein may be combined with any one or more of the other teachings, expressions, embodiments, examples, etc. that are described herein. The above-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Having shown and described various versions of the present invention, further adaptations of the methods, systems, and apparatus described herein may be accomplished by appropriate modifications by one of ordinary skill in the art without departing from the scope of the present invention. Several of such potential modifications have been mentioned, and others will be apparent to those skilled in the art. For instance, the examples, versions, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method for detecting, tracking, managing, and charging for parking space usage, the method comprising:
sensing, by at least one computer vision system, at least one vehicle's appearance into at least one image frame;
capturing, by at least one capture device, at least one image of the at least one vehicle's appearance into the image frame, and the at least one vehicle's ingress to and occupancy of at least one monitored parking space;
storing, by at least one computer processor, the at least one image within a medium of computer readable memory with a beginning timestamp identifying the at least one vehicle's ingress to the at least one monitored parking space;
identifying, by at least one computer processor, at least one parameter of vehicle identification for the at least one vehicle;
tracking, by at least one computer vision system, the at least one vehicle's presence in a plurality of the at least one images, wherein the computer vision system includes tracking software that accounts for obstructions that may prevent the capture of images of the at least one vehicle in the at least one image frame;
sensing, by at least one computer vision system, the at least one vehicle's egress from the at least one monitored parking space;
capturing, by at least one capture device, at least one image of the at least one vehicle's egress from the at least one monitored parking space with an ending timestamp identifying the at least one vehicle's egress from the at least one monitored parking space;
storing, by at least one computer processor, the at least one image within the medium of computer readable memory;
verifying, by at least one computer processor, the at least one parameter of vehicle identification for the egressed at least one vehicle parked in the at least one monitored parking space;
transmitting, by at least one computer processor and via a network, data captured from the at least one computer vision system to a server pertaining to the at least one vehicle's ingress, presence, and egress from the at least one monitored parking space and the at least one parameter of vehicle identification;
calculating, by at least one computer processor, the duration of time between the at least one vehicle's ingress to and egress from the at least one monitored parking space;
calculating, by at least one computer processor, a fee for the duration of time that the at least one vehicle occupied the at least one monitored parking space;
determining, by at least one computer processor, whether the at least one vehicle is subject to at least one additional fee;
determining, by at least one computer processor, whether a transactionable event has occurred by the at least one vehicles ingress, presence, and egress from the at least one monitored parking space;
calculating, by at least one computer processor, a total fee that is a combination of the fee and, if applicable, the at least one additional fee;
generating, by at least one computer process, an invoice for the total fee owed for the at least one vehicle's ingress, presence, and egress from the at least one monitored parking space;
verifying, by at least one computer processor, whether the identified at least one vehicle is connected to a user's registered user account within at least one user database, wherein the registered user account on the at least one user database includes a pre-registered payment method and a pre-authorization for charges associated with fees for the at least one vehicle connected to the registered user account; and
sending, by at least one computer processor and via the network, the total fee on the invoice to the registered user for the at least one vehicle's ingress, presence, and egress from the at least one monitored parking space.

2. The method of claim 1 wherein the at least one computer vision system includes the at least one capture device and at least one optical component.

3. The method of claim 2 further comprising the at least one computer vision system includes a frame grabber.

4. The method of claim 1 wherein the at least one image is transmitted over a network to be stored within a medium of computer readable memory.

5. The method of claim 1 wherein the at least one parameter of vehicle identification is selected from the group consisting of vehicle make, vehicle model, vehicle color, license plate, identifying details of the vehicle, identifying tag, identifying sticker, transmitter, and combinations thereof.

6. The method of claim 1 wherein the calculation of the fee for the duration of time that the at least one vehicle occupied the at least one monitored parking space and the additional fee, if applicable, is generated by a policy API.

7. The method of claim 1 wherein the at least one user database is selected from the group consisting of a privately owned database, a state department of motor vehicles database, a government-owned database, a collection of databases, and combinations thereof.

8. The method of claim 1 further comprising the step of processing, by at least one computer processor, an automatic payment transaction for the total fee on the invoice from the user's pre-registered payment method.

9. The method of claim 1 wherein a digital wallet on the registered user account automatically charges another of the user's pre-registered payment methods to refill the digital wallet when the digital wallet is below a certain threshold.

10. The method of claim 9 wherein the digital wallet contains at least one form of cryptocurrency to use as payment.

11. An automated curbside parking system, the system comprising:
at least one computer vision system comprising:
at least one capture device directed to capture at least one image of at least one vehicle's appearance in at least one image frame, and the at least one vehicle's ingress into and egress from at least one monitored parking space;
at least one computer processor;
at least one unit of computer memory containing at least one set of instructions controlling the operation of the computer vision system, identifying at least one parameter of vehicle identification for the at least one vehicle, tracking the at least one vehicle's presence in the at least one image, and for storing the at least one image captured by the at least one capture device; and
at least one communication unit;
at least one server comprising:
at least one computer processor;
at least one unit of computer memory containing at least one set of instructions;
wherein the at least one set of instructions includes at least one Policy API, at least one invoice generating routine, at least one payment gateway, and at least one user interface;
at least one network interface;
the at least one monitored parking space that is monitored by the computer vision system;
wherein the computer vision system is configured to:
sense the at least one vehicle's appearance into the at least one image frame;
capture at least one image of the at least one vehicle's appearance into the image frame, and the at least one vehicle's ingress to and occupancy of at least one monitored parking space;
store the at least one image within the medium of computer readable memory;
identify at least one parameter of vehicle identification for the at least one vehicle;
track the at least one vehicle's presence in a plurality of the at least one images, wherein the computer vision system's instructions for tracking accounts for obstructions that may prevent the capture of images of the at least one vehicle in the at least one image frame;
sense the at least one vehicle's egress from the at least one monitored parking space;
capture at least one image of the at least one vehicle's egress from the at least one monitored parking space;
store the at least one image within the medium of computer readable memory;
verify the at least one parameter of vehicle identification for the egressed at least one vehicle parked in the at least one monitored parking space;
transmit data captured from the at least one computer vision system to the at least one server pertaining to the at least one vehicle's ingress, presence, and egress from the at least one monitored parking space and the at least one parameter of vehicle identification;
wherein the server is configured to:
receive the computer vision system's data via the server's network interface;
calculate the duration of time between the at least one vehicle's ingress to and egress from the at least one monitored parking space;
calculate a fee for the duration of time that the at least one vehicle occupied the at least one monitored parking space;
determine whether the at least one vehicle is subject to at least one additional fee;
determine whether a transactionable event has occurred by the at least one vehicles ingress, presence, and egress from the at least one monitored parking space;
calculate a total fee that is a combination of the fee and, if applicable, the at least one additional fee;
generate an invoice for the total fee owed for the at least one vehicle's ingress, presence, and egress from the at least one monitored parking space;
verify whether the identified at least one vehicle is connected to a user's registered user account within at least one user database, wherein the registered user account on the at least one user database includes a pre-registered payment method and a pre-authorization for charges associated with fees for the at least one vehicle connected to the registered user account; and
transmit the invoice to the registered user for the at least one vehicle's ingress, presence, and egress from the at least one monitored parking space.

12. The system of claim 11 wherein the server includes the at least one database containing information for at least one registered user account.

13. The system of claim 11 wherein the server is further configured to automatically process a payment transaction from the user for the total fee on the invoice because of the settings and information provided by the user in the registered user account.

14. The system of claim 11 further comprising at least one user-facing application installed on a user's device and configured to allow the user to interact with the system via a graphical user interface and providing the user with the ability for the user to register an account, edit account details, add at least one payment method, register at least one vehicle to the registered user account, and provide at least one pre-authorization for the at least one payment method which covers charges related to the at least one vehicle's parking fees, fines, and charges.

15. The system of claim 11 further comprising at least one website configured to allow users, via the user's device, to interact with the system via a graphical user interface and providing the user with the ability for the user to register an account, edit account details, add at least one payment method, register at least one vehicle to the registered user account, and provide at least one pre-authorization for the at least one payment method which covers charges related to the at least one vehicle's parking fees, fines, and charges.

16. The system of claim 11 further comprising at least one external database configured to supply data to the system.

17. The system of claim 16 wherein the at least one external database is operated by a government body having authority over transportation and contains data selected from the group consisting of user driving information, user vehicle information, user payment information, user pre-authorizations, user driving history, user insurance information, vehicle history, and combinations thereof.

18. The system of claim 16 wherein the at least one external database is owned by a private body and contains data selected from the group consisting of user driving information, user vehicle information, user payment information, user pre-authorizations, user driving history, user insurance information, vehicle history, and combinations thereof.

19. The system of claim 11 wherein the computer vision system further comprises at least one optical component.

20. The system of claim 11 wherein the computer vision system further comprises at least one frame grabbing mechanism configured to identify and store desired frames from image data to the computer vision system's memory.

21. The system of claim 11 wherein the server is configured to communicate with an external payment gateway for the user to resolve payment of the invoice.

22. A method for detecting, tracking, managing, and charging for parking space usage, the method comprising:
sensing, by at least one computer vision system, at least one vehicle's appearance into at least one image frame;
capturing, by at least one capture device, at least one image of the at least one vehicle's appearance into the image frame, and the at least one vehicle's ingress to and occupancy of at least one monitored parking space;
storing, by at least one computer processor, the at least one image within a medium of computer readable memory with a beginning timestamp identifying the at least one vehicle's ingress to the at least one monitored parking space;
identifying, by at least one computer processor, at least one parameter of vehicle identification for the at least one vehicle;
tracking, by at least one computer vision system, the at least one vehicle's presence in a plurality of the at least one images, wherein the computer vision system includes tracking software that accounts for obstructions that may prevent the capture of images of the at least one vehicle in the at least one image frame;
sensing, by at least one computer vision system, the at least one vehicle's egress from the at least one monitored parking space;
capturing, by at least one capture device, at least one image of the at least one vehicle's egress from the at least one monitored parking space with an ending timestamp identifying the at least one vehicle's egress from the at least one monitored parking space;
storing, by at least one computer processor, the at least one image within the medium of computer readable memory;
verifying, by at least one computer processor, the at least one parameter of vehicle identification for the egressed at least one vehicle parked in the at least one monitored parking space;
transmitting, by at least one computer processor and via a network, data captured from the at least one computer vision system to a server pertaining to the at least one vehicle's ingress, presence, and egress from the at least one monitored parking space and the at least one parameter of vehicle identification;
calculating, by at least one computer processor, the duration of time between the at least one vehicle's ingress to and egress from the at least one monitored parking space;
calculating, by at least one computer processor, a fee for the duration of time that the at least one vehicle occupied the at least one monitored parking space;
determining, by at least one computer processor, whether the at least one vehicle is subject to at least one additional fee;
determining, by at least one computer processor, whether a transactionable event has occurred by the at least one vehicles ingress, presence, and egress from the at least one monitored parking space;
calculating, by at least one computer processor, a total fee that is a combination of the fee and, if applicable, the at least one additional fee;
generating, by at least one computer process, an invoice for the total fee owed for the at least one vehicle's ingress, presence, and egress from the at least one monitored parking space;
verifying, by at least one computer processor, whether the identified at least one vehicle is connected to a user's registered user account within at least one user database; and
storing, by at least one computer processor, the data for the aggregate total fee owed for each identified at least one vehicle use of the at least one monitored parking space.

23. The method of claim 22 wherein the at least one computer vision system includes at least one capture device and at least one optical component.

24. The method of claim 22 further comprising the at least one computer vision system includes a frame grabber.

25. The method of claim 22 wherein the at least one image is transmitted over a network to be stored within a medium of computer readable memory.

26. The method of claim 22 wherein the at least one parameter of vehicle identification is selected from the group consisting of vehicle make, vehicle model, vehicle color, license plate, identifying details of the vehicle, identifying tag, identifying sticker, transmitter, and combinations thereof.

27. The method of claim 22 wherein the calculation of the fee for the duration of time that the at least one vehicle occupied the at least one monitored parking space and the additional fee, if applicable, is generated by a policy API.

28. The method of claim 22 further comprising unregistered users interacting with a parking interface apparatus that provides unregistered users with the ability to pay the invoice for that user's at least one vehicle's occupancy of the at least one monitored parking space.

29. The method of claim 22 further comprising the step of sending, by at least one computer processor and via a network, the data for the aggregate total fee owed for each identified at least one vehicle's occupancy of the at least one monitored parking space to a third party processor to communicate with the user and collect payment for the aggregate total fee.

30. A method for detecting, tracking, managing, and charging for parking space usage, the method comprising:
sensing, by at least one computer vision system, at least one vehicle's appearance into at least one image frame;
capturing, by at least one capture device, at least one image of the at least one vehicle's appearance into the image frame, and the at least one vehicle's ingress to and occupancy of at least one monitored parking space;
storing, by at least one computer processor, the at least one image within a medium of computer readable memory with a beginning timestamp identifying the at least one vehicle's ingress to the at least one monitored parking space;
identifying, by at least one computer processor, at least one parameter of vehicle identification for the at least one vehicle;
tracking, by at least one computer vision system, the at least one vehicle's presence in a plurality of the at least one images, wherein the computer vision system includes tracking software that accounts for obstructions that may prevent the capture of images of the at least one vehicle in the at least one image frame;
sensing, by at least one computer vision system, the at least one vehicle's egress from the at least one monitored parking space;
capturing, by at least one capture device, at least one image of the at least one vehicle's egress from the at least one monitored parking space with an ending timestamp identifying the at least one vehicle's egress from the at least one monitored parking space;
storing, by at least one computer processor, the at least one image within the medium of computer readable memory;
verifying, by at least one computer processor, the at least one parameter of vehicle identification for the egressed at least one vehicle parked in the at least one monitored parking space;
determining, by at least one computer processor, whether a transactionable event has occurred by the at least one vehicles ingress, presence, and egress from the at least one monitored parking space;
transmitting, by at least one computer processor and via a network, data captured from the at least one computer vision system to a server pertaining to the at least one vehicle's ingress, presence, and egress from the at least one monitored parking space and the at least one parameter of vehicle identification for the positively determined transactionable event;
calculating, by at least one computer processor, the duration of time between the at least one vehicle's ingress to and egress from the at least one monitored parking space;
calculating, by at least one computer processor, a fee for the duration of time that the at least one vehicle occupied the at least one monitored parking space;
determining, by at least one computer processor, whether the at least one vehicle is subject to at least one additional fee;
calculating, by at least one computer processor, a total fee that is a combination of the fee and, if applicable, the at least one additional fee;
generating, by at least one computer process, an invoice for the total fee owed for the at least one vehicle's ingress, presence, and egress from the at least one monitored parking space;
verifying, by at least one computer processor, whether the identified at least one vehicle is connected to a user's registered user account within at least one user database, wherein the registered user account on the at least one user database includes a pre-registered payment method and a pre-authorization for charges associated with fees for the at least one vehicle connected to the registered user account;
sending, by at least one computer processor and via the network, the total fee on the invoice to the registered user for the at least one vehicle's ingress, presence, and egress from the at least one monitored parking space; and
processing, by at least one computer processor, an automatic payment transaction for the total fee on the invoice from the user's pre-registered payment method.

31. The method of claim 2 wherein the at least one computer vision system includes the at least one lightning component.

32. The method of claim 23 wherein the at least one computer vision system includes the at least one lightning component.

33. The method of claim 2 wherein the at least one image of the at least one vehicle includes the at least one parameter of vehicle identification to mark the vehicle.

34. The method of claim 23 wherein the at least one image of the at least one vehicle includes the at least one parameter of vehicle identification to mark the vehicle.
